(19) United States
(12) Patent Application Publication
(10) Pub. No.: US 2014/0218333 A1
(43) Pub. Date: Aug. 7, 2014

(54) COORDINATE CALCULATING METHOD AND TOUCH MODULE FOR SINGLE-LAYER CAPACITIVE TOUCH DEVICE

(71) Applicant: NOVATEK Microelectronics Corp., Hsin-Chu (TW)

(72) Inventor: Shun-Li Wang, Hsinchu City (TW)

(73) Assignee: NOVATEK Microelectronics Corp., Hsin-Chu (TW)

(21) Appl. No.: 13/968,450

(22) Filed: Aug. 16, 2013

(30) Foreign Application Priority Data
Feb. 4, 2013 (TW) 102104225

(51) Int. Cl. G06F 3/044

(52) U.S. Cl. CPC G06F 3/044
USPC 345/174

(57) ABSTRACT

A coordinate calculating method includes acquiring a plurality of first end capacitances and a plurality of second end capacitances corresponding to a plurality of sensing channels of a single-layer capacitive touch device. Differences between the plurality of first end capacitances and a plurality of first baselines are calculated for acquiring a plurality of first differences and calculating differences between the plurality of second end capacitances and a plurality of second baselines for acquiring a plurality of second differences The first difference and the second difference of each sensing channel are added for acquiring a plurality of total capacitances. Whether the single-layer capacitive touch device is pressed is determined according to the plurality of total capacitances and a threshold. A coordinate of at least one touch point is outputted when determining the single-layer capacitive touch device is pressed.

### BACKGROUND OF THE INVENTION

1. Field of the Invention

The present invention relates to a coordinate calculating method and a touch device, and more particularly, to a coordinate calculating method and a touch device for a single-layer capacitive touch device with a plurality of sensing channels.

2. Description of the Prior Art

Recently, touch panels are widely used in the input interfaces of electronic devices due to the human-computer interaction characteristic of the touch panels. With the applications of consumer electronic products becoming broader, the spectrum of electronic products equipped with touch display panel, such as mobile phones, GPS navigator systems, tablets, PDAS, and laptops, continues to increase. According to different methods of sensing touch, the touch panels can be classified as resistive, capacitive, acoustic pulse and infrared. The resistive touch panels and the capacitive touch panels are commonly used in the industry. Since the capacitive touch panels have characteristics such as good tolerability and good user experience, the capacitive touch panels has become the mainstream in the industry.

Please refer to FIG. 1, which is a schematic diagram of sensing pads in a conventional projective capacitive touch (PCT) device 10. The PCT device 10 utilizes two conductive layers to realize the sensing pad, for easily performing scan operations of the circuit in two directions. The PCT device 10 includes a touch panel (not shown) using a glass substrate (e.g. a cover layer (not shown)) formed on the glass substrate, Y-axis sensing pads 100 formed on the upper side of the glass substrate, and X-axis sensing pads 102 formed on the lower side of the glass substrate. The Y-axis sensing pads 100 (located on the axes y1, y2, y3, y4) are separated by the fixed space. The X-axis sensing pads 102 (located on the axes x1, x2, x3, x4) are orthogonal to the Y-axis sensing pads 102 and separated by the fixed space. When the finger touches or approaches the cover layer, the capacitance variation of the X-axis sensing pad 102 and Y-axis sensing pad 100 at the touch point is detected by the control circuit to generate the coordinate data of the X-axis and Y-axis. The double-layer PCT device 10 has to form the X-axis sensing pads 102 and Y-axis sensing pads 100 on the lower side and upper side of the glass substrate respectively. In general, the transparent sensing pads are made of Indium-Tin-Oxide (ITO), so the cost is higher. To reduce the cost of the double-layer PCT device 10, the single-layer capacitive touch device is developed.

Please refer to FIG. 2, which is a schematic diagram of a conventional single-layer capacitive touch device 20. The difference between the single-layer capacitive touch device 20 and the double-layer CPT device 10 is that the single-layer capacitive touch device 20 forms the sensing pads only on one side of the glass substrate. There is a plurality of triangular sensing pads 200 formed along the X-axis of the glass substrate and separated by the fixed space. Every two triangular sensing pads 200 are arranged symmetrically to form a long rectangle parallel to the Y-axis. The plurality of triangular sensing pads forms a plurality of sensing pad pairs stacked along the X-axis. In this way, via detecting the capacitance variation cross each sensing pad pair (i.e. sensing ends A1-A8, B1-B8), the single-layer capacitive touch device 20 utilizes single-layer ITO to realize the design of multi-points touch control. The best advantage of the single-layer capacitive touch device is the reduction of cost.

If the number of sensing pad pairs corresponding to each sensing end (i.e. sensing ends A1-A8, B1-B8) increases, the touch resolution of the single-layer capacitive touch device 20 can be improved. Please refer to FIG. 3, which is a schematic diagram of a conventional single-layer capacitive touch device 30. In comparison with the single-layer capacitive touch device 20, the sensing ends A1, A8, B1, B8 located at edges of the single-layer capacitive touch device 30 correspond to two sensing pad pairs 202, respectively. The sensing ends A2-A7, B2-B7 of the single-layer capacitive touch device 30 correspond to three sensing pad pairs 202, respectively. Via increasing the number of the sensing pad pairs corresponding to each sensing end, both the touch resolution and the touch accuracy of the single-layer capacitive touch device 30 are improved.

Since the single-layer capacitive touch device only detects capacitance variation in a single direction (i.e. Y-axis), the single-layer capacitive touch device needs a special coordinate algorithm to acquire precise data of touch points, however. In other words, when using the thin low-cost single-layer capacitive touch device, a well-designed coordinate algorithm is needed for acquiring good touch resolution.

### SUMMARY OF THE INVENTION

Therefore, the present invention discloses a coordinate calculating method and a touch module for a single-layer capacitive touch device.

The present invention discloses a coordinate calculating method for a single-layer capacitive touch device having a plurality of sensing channels, wherein each sensing channel corresponds to at least one sensing pad pairs, a first end and a second end. The coordinate calculating method comprises: acquiring a plurality of first end capacitances and a plurality of second end capacitances corresponding to the plurality of sensing channels; calculating differences between the plurality of first end capacitances and a plurality of first baselines for acquiring a plurality of first differences and calculating differences between the plurality of second end capacitances and a plurality of second baselines for acquiring a plurality of second differences; adding the first difference and the second difference corresponding to each sensing channel for acquiring a plurality of total capacitances; and determining whether the single-layer capacitive touch device is pressed according to the plurality of total capacitances and a threshold, and outputting a coordinate of at least one touch point when the single-layer capacitive touch device is pressed.

The present invention further discloses a touch module. The touch module comprises: a single-layer capacitive touch device; a processing unit; and a storage unit for storing a program code. The program code instructs the processing unit to perform the following steps: acquiring a plurality of first end capacitances and a plurality of second end capacitances corresponding to the plurality of sensing channels; calculating differences between the plurality of first end capacitances and a plurality of first baselines for acquiring a plurality of first differences and calculating differences between the plurality of second end capacitances and a plurality of second baselines for acquiring a plurality of second differences; adding the first difference and the second difference corresponding to each sensing channel for acquiring a plurality of total capacitances; determining whether the single-layer capacitive touch device is pressed according to the plurality of total capacitances and a threshold; and outputting coordinate of at least one touch point when the single-layer capacitive touch device is pressed

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional projective capacitive touch device.

FIG. 2 is a schematic diagram of a conventional single-layer capacitive touch device.

FIG. 3 is a schematic diagram of another conventional single-layer capacitive touch device.

FIG. 4 is a schematic diagram of a capacitive touch control module according to an embodiment of the present invention.

FIG. 5 is a flowchart of a coordinate calculating method according to an embodiment of the present invention.

FIG. 6A and FIG. 6B are flowcharts of an implementation of the coordinate calculating method shown in FIG. 5.

FIG. 7 is a schematic diagram of an exemplary single-layer capacitive touch device.

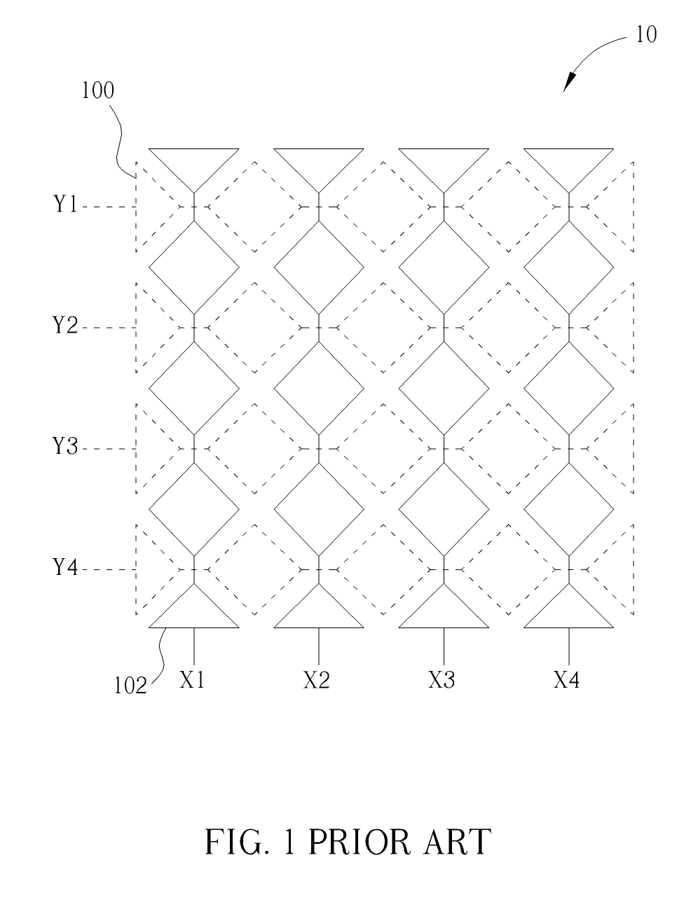

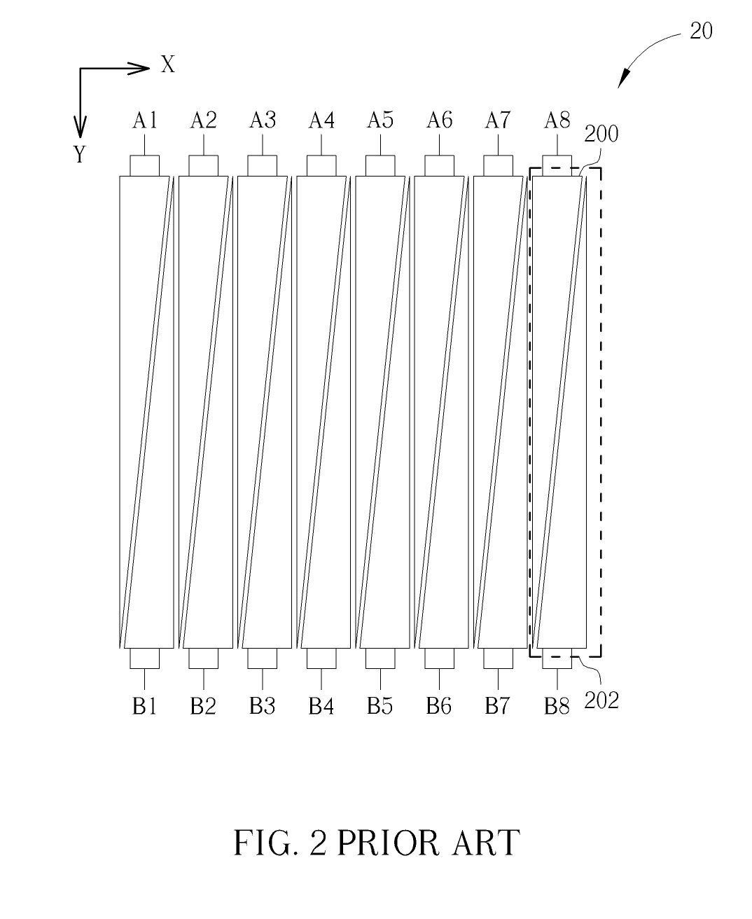

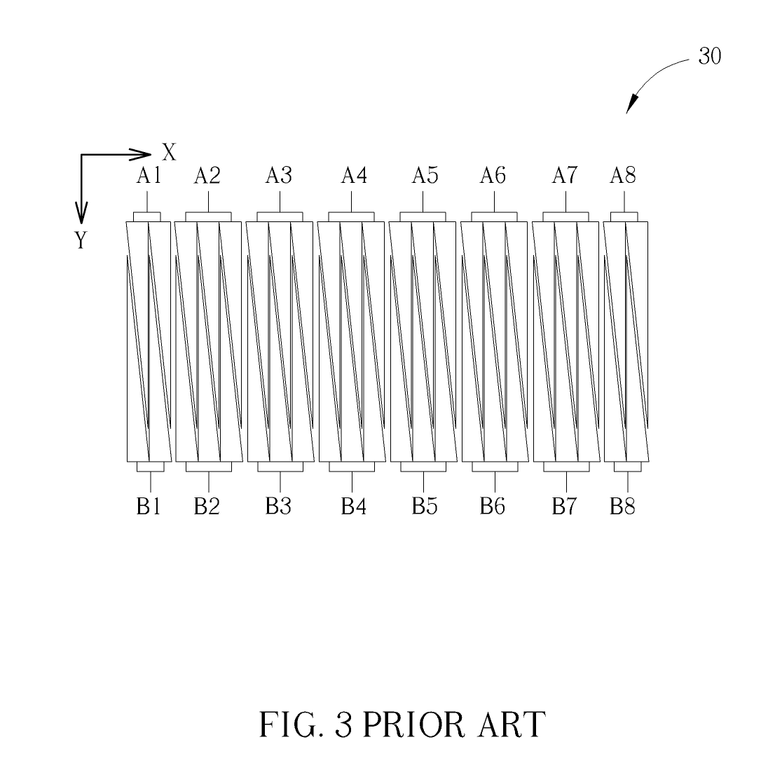

### DETAILED DESCRIPTION

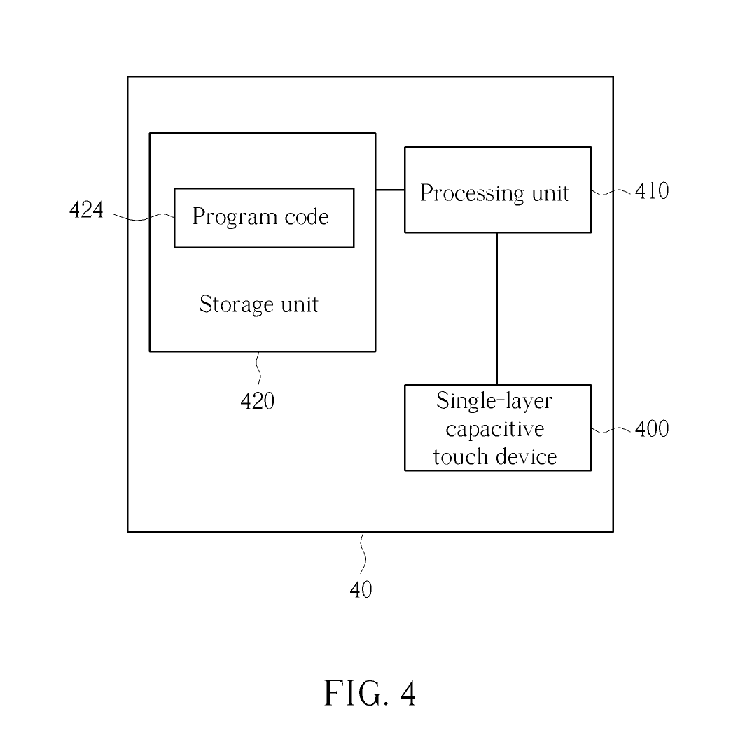

Please refer to FIG. 4, which is a schematic diagram of a capacitive touch module 40 according to an embodiment of the present invention. The capacitive touch module 40 may be utilized in a multi-media mobile system, but is not limited herein. The capacitive touch module 40 comprises a single-layer capacitive touch device 400, a processing unit 410 and a storage unit 420. The single-layer capacitive touch device maybe a single-layer capacitive touch panel, but is not limited herein. The processing unit 410 may be a microprocessor or an Application Specific Integrated Circuit (ASIC). The storage unit 420 may be any data storage device that can store a program code 424 to be accessed by the processing unit 410. Examples of the storage unit 420 include, but are not limited to, a subscriber identity module (SIM), read-only memory (ROM), flash memory, random-access memory (RAM), CD-ROM/DVD-ROM, magnetic tape, hard disk, and optical data storage device.

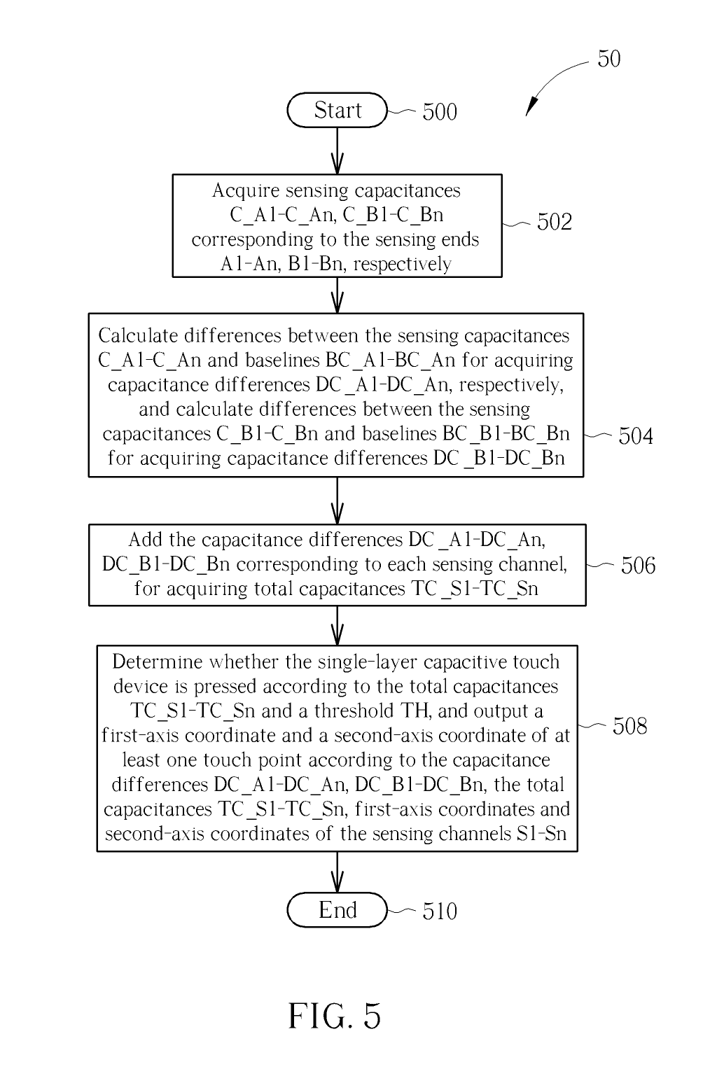

Please refer to FIG. 5, which is a flowchart of a coordinate calculating method 50 according to an embodiment of the present invention. The coordinate calculating method 50 is utilized for a single-layer capacitive touch device of a capacitive touch module, wherein the single-layer capacitive touch device has sensing channels S1-Sn corresponding to at least one sensing pad pair, sensing ends A1-An and sensing ends B1-B8. The sensing ends A1-An and the sensing ends B1-Bn are located at different sides of the sensing channels S1-Sn, respectively. The coordinate calculating method 50 can be compiled into the program code 424 shown in FIG. 4 and includes the following steps.

Step 500: Start.

Step 502: Acquire sensing capacitances C_A1-C_An, CB_1-C_Bn corresponding to the sensing ends A1-An, B1-Bn, respectively.

Step 504: Calculate differences between the sensing capacitances C_A1-C_An and baselines BC_A1-BC_An for acquiring capacitance differences DC_A1-DC_An, respectively, and calculate differences between the sensing capacitances CB₁₃ 1-C_Bn and baselines BC_B1-BC_Bn for acquiring capacitance differences DC_B1-DC_Bn.

Step 506: Add the capacitance differences DC_A1-DC_An, DC_B1-DC_Bn corresponding to each sensing channel, for acquiring total capacitances TC_S1-TC_Sn.

Step 508: Determine whether the single-layer capacitive touch device is pressed according to the total capacitances TC_S1-TC_Sn and a threshold TH, and output a first-axis coordinate and a second-axis coordinate of at least one touch point according to the capacitance differences DC_A1-DC_An, DC_B1-DC₋Bn, the total capacitances TC_S1-TC_Sn, first-axis coordinates and second-axis coordinates of the sensing channels S1-Sn.

Step 510: End.

As to the details of the coordinate calculating method 50 please refer to the following. The capacitive touch module detects capacitance variations generated when the single-layer capacitive touch device is pressed or capacitance variations relative to the environmental capacitances to calculate the coordinate of the touch point on the single-layer capacitive touch device. Thus, the capacitive touch module 40 first acquires the sensing capacitances C_A1-C_An, C_B1-C_Bn corresponding to the sensing ends A1-An, B1-Bn, respectively, and calculates the differences between the sensing capacitances C_A1-C_An, CB_1-C_Bn and the baselines BC_A1-BC_An, BC_B1-BC_Bn, for acquiring the capacitance differences DC_A1-DC_An, DC_B1-DC_Bn (steps 502,504). The baselines BC_A1-BC_An, BC_B1-BC_Bn are acquired by detecting environmental capacitances (e.g. the environmental capacitances generated by the surface traces, metal line and Indium-Tin-Oxide traces of the capacitive touch module) when the capacitive touch module initializes. Next, the capacitive touch module adds the capacitance differences DC_A1-DC_An, DC_B1-DC_Bn corresponding to each sensing channel, for acquiring the total capacitances TC_S1-TC_Sn of the sensing channels S1-Sn, respectively. Since the sensing capacitances of the sensing channel will be much greater than the baseline of the sensing channel when the sensing channel is pressed, the capacitive touch module can determine whether the single-layer capacitive touch device is pressed according to whether the total capacitances TC_S1-TC_Sn are greater than the threshold TH. The capacitive touch module also learns the number of the touch points when determining the single-layer touch device is pressed. Further, when determining the single-layer touch device is pressed, the capacitive touch module acquires the coordinates of the touch points according to the capacitance differences DC_A1-DC_An, DC_B1-DC_Bn, the total capacitances TC_S1-TC_Sn, the first-axis coordinates and the second-axis coordinates of the sensing channels S1-Sn.

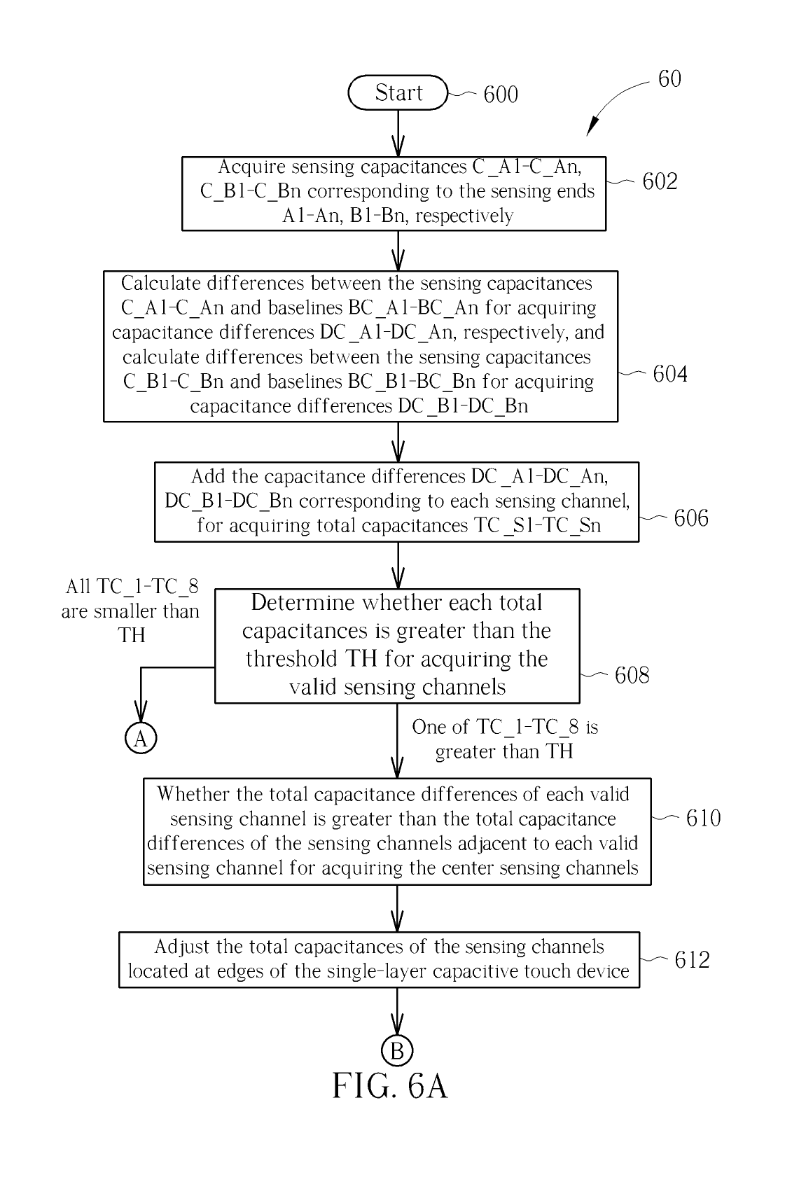

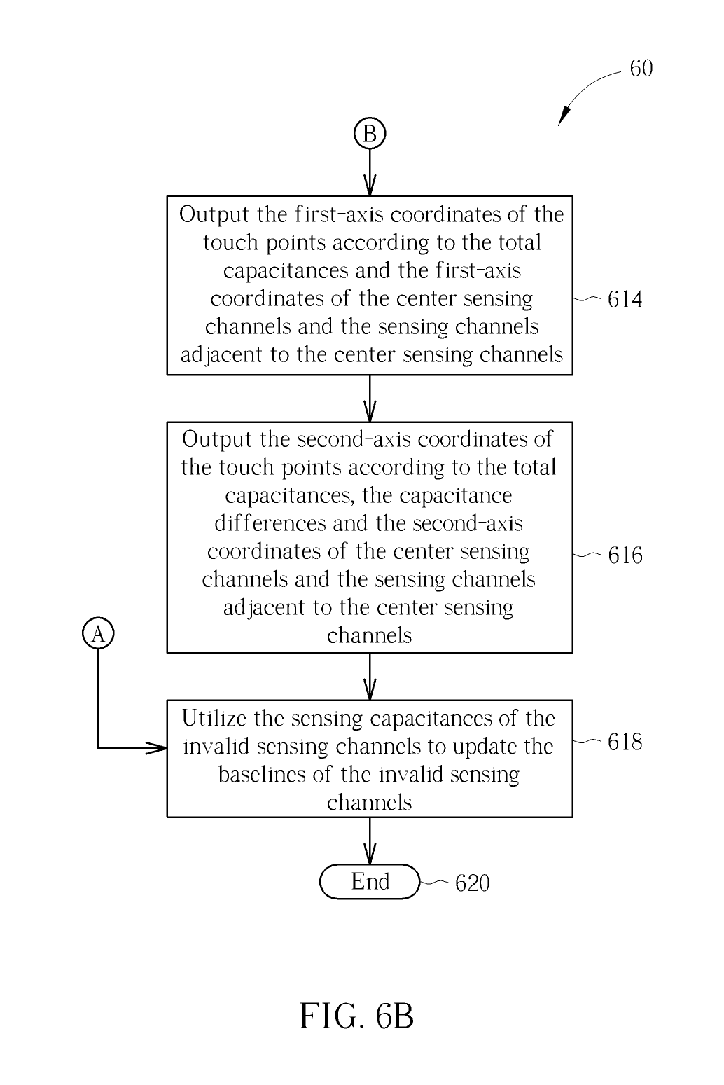

According to different applications, there are various methods for acquiring the coordinates of the touch points according to the capacitance differences DC_A1-DC_An, DC_B1-DC_Bn, the total capacitances TC_S1-TC_Sn, the first-axis coordinates and the second-axis coordinates of the sensing channels S1-Sn. Please refer to FIG. 6A and FIG. 6B, which are flowcharts of an implementation of the coordinate calculating method 50 shown in FIG. 5. As shown in FIG. 6A and FIG. 6B, a coordinate calculating method 60 comprises the following steps.

Step 600: Start.

Step 602: Acquire sensing capacitances C_A1-C_An, C_B1-C_Bn corresponding to the sensing ends A1-An, B1-Bn, respectively.

Step 604: Calculate differences between the sensing capacitances C_A1-C_An and baselines BC_A1-BC_An for acquiring capacitance differences DC_A1-DC_An, respectively, and calculate differences between the sensing capacitances C_B1-C_Bn and baselines BC_B1-BC_Bn for acquiring capacitance differences DC_B1-DC_Bn.

Step 606: Add the capacitance differences DC_A1-DC_An, DC_B1-DC_Bn corresponding to each sensing channel, for acquiring total capacitances TC_S1-TC_Sn.

Step 608: Determine whether each total capacitances is greater than the threshold TH. When a first total capacitance is greater than the threshold TH, determine the sensing channel corresponding to the first total capacitance is a valid sensing channel and perform step 610; otherwise, determine the sensing channel corresponding to the first total capacitance is an invalid sensing channel and perform step 618.

Step 610: Determine whether the total capacitance differences of each valid sensing channel is greater than the total capacitance differences of the sensing channels adjacent to each valid sensing channel. If the total capacitance difference of a first valid sensing channel is greater than the total capacitance differences of the sensing channels adjacent to the first valid sensing channel, determine the first valid sensing channel is a center sensing channel.

Step 612: Adjust the total capacitances of the sensing channels located at edges of the single-layer capacitive touch device.

Step 614: Output the first-axis coordinates of the touch points according to the total capacitances and the first-axis coordinates of the center sensing channels and the sensing channels adjacent to the center sensing channels.

Step 616: Output the second-axis coordinates of the touch points according to the total capacitances, the capacitance differences and the second-axis coordinates of the center sensing channels and the sensing channels adjacent to the center sensing channels.

Step 618: Utilize the sensing capacitances of the invalid sensing channels to update the baselines of the invalid sensing channels.

Step 620: End.

As to the details of the coordinate calculating method 50 please refer to the following. The operations of steps 602-606 are similar to steps 502-506 of the coordinate calculating method 50 shown in FIG. 5, and are not narrated herein for brevity. After acquiring the capacitance differences DC_A1-DC_An, DC_B1-DC_Bn and the total capacitances TC_S1-TC_Sn, the capacitive touch module determines whether the single-layer capacitive touch device is pressed according to whether the total capacitance TC_S1-TC_Sn are greater than the threshold TH, respectively. Since the sensing capacitances of the sensing channel will be much greater than the baseline of the sensing channel when the sensing channel is pressed, the capacitive touch module determines the sensing channels corresponding to the total capacitances greater than the threshold TH as the valid sensing channels. Generally, when the distance between the sensing channel and the touch point is closer, the sensing capacitances of the sensing channel are greater. The capacitive touch module determines whether the total capacitance of each valid sensing channel is greater than that of sensing channel adjacent to each valid sensing channel, for determining the sensing channel having the smallest distance with the touch point. If the total capacitance difference of the first valid sensing channel is greater than the total capacitance differences of the sensing channels adjacent to the first valid sensing channel, the capacitive touch module determines the first valid sensing channel is the center sensing channel (steps 608, 610).

Since the structure of the single-layer capacitive touch device may be asymmetric, the total capacitances and the capacitance differences of the sensing channels located at the edges of the single-layer capacitive touch device need to be adjusted for acquiring accurate results (step 612). Next, the first-axis coordinates and the second-axis coordinates of the touch points can be obtained according to the total capacitances, the capacitance differences and the second-axis coordinates of the center sensing channels and the sensing channels adjacent to the center sensing channels (steps 614, 616). After acquiring information of the touch points, the capacitive touch module utilizes the sensing capacitances corresponding to the total capacitances smaller than the threshold TH (i.e. the sensing capacitances corresponding to the invalid sensing channels) to update the baselines of the invalid sensing channels (step 618). Please note that, if all the total capacitances TC_S1-TC_Sn are smaller than the threshold TH (i.e. there is zero valid sensing channel), the capacitive touch module can directly perform step 618.

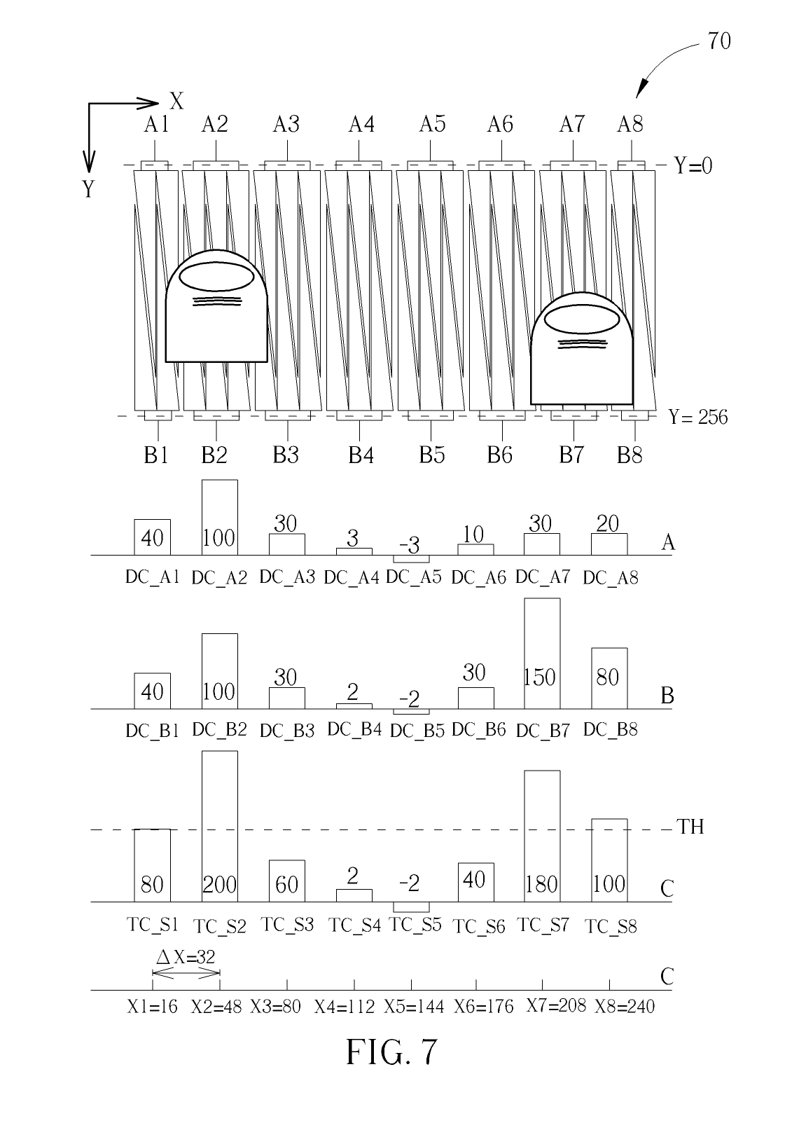

Please refer to FIG. 7, which is a schematic diagram of an exemplary single-layer capacitive touch device 70. As shown in FIG. 7, the single-layer capacitive touch device 70 includes sensing channels S1-S8 stack in parallel to the Y-axis (i.e. second-axis) and touch points P1, P2 located at the sensing channels S2, S7, respectively. The sensing channels S1-S8 correspond to sensing ends A1-A8, sensing ends B1-B8 and X-axis (i.e. first-axis) coordinates X1-X8. The sensing ends A1-A8 correspond to the Y-axis coordinate 0 and the Y-axis coordinate 256. In the total capacitances TC_S1-TC_S8, the total capacitances TC_S1, TC_S2, TC_S7, TC_S8 are greater than the threshold TH. Thus, the sensing channels S1, S2, S7, S8 are the valid sensing channels. Further, since the total difference TC_S2 is greater than the total differences TC_S1, TC_S3, the sensing channel S2 is determined to be the center sensing channel. Similarly, the sensing channel S7 is also the center sensing channel. Please note that, in order to simplify the descriptions, the capacitor differences DC_A1, DC_A8 and the total capacitances TC_S1, TC_S8 of the sensing channels S1, S8, which locate at the edges of the single-layer capacitive touch device 70, are not adjusted in this embodiment.

The X-axis coordinates XP1, XP2 of the touch points P1, P2 can be obtained according to the total capacitances TC_S2, TC_S7 of the center sensing channels S2, S7 and the total capacitances TC_S1, TC_S3, TC_S6, TC_S8 of the sensing channels S1, S3, S6, S8 adjacent to the center sensing channels S2, S7. In this embodiment the X-axis coordinates XP1, XP2 of the touch points P1, P2 are acquired by interpolation, but are not limited herein. The formula of calculating the coordinate XP1 of the touch point P1 can be expressed as:

$$XP 1 = \frac{{\sum }_{n = i - 1}^{i + 1} TC\_Sn \times Xn}{{\sum }_{n = i - 1}^{i + 1} TC\_Sn} , \\ ( i = 2 ) ⇒ XP 1 = \frac{( 80 \times 16 + 200 \times 48 + 60 \times 80 )}{( 80 + 200 + 60 )} = 46$$

Similarly, the formula of calculating the coordinate XP2 of the touch point P2 can be expressed as:

$$XP 2 = \frac{{\sum }_{n = i - 1}^{i + 1} TC\_Sn \times Xn}{{\sum }_{n = i - 1}^{i + 1} TC\_Sn} , \\ ( i = 7 ) ⇒ XP 2 = \frac{( 40 \times 176 + 180 \times 208 + 100 \times 240 )}{( 40 + 180 + 100 )} = 214$$

The X-axis coordinates XP1, XP2 of the touch points P1, P2 are therefore obtained. Via the similar method, the formulas of calculating the Y-axis coordinates YP1, YP2 of the touch points P1, P2 can be expressed as:

$$YP 1 = \frac{{\sum }_{n = i - 1}^{i + 1} DC\_An}{{\sum }_{n = i - 1}^{i + 1} TC\_Sn} \times 0 + \frac{{\sum }_{n = i - 1}^{i + 1} DC\_Bn}{{\sum }_{n = i - 1}^{i + 1} TC\_Sn} \times 256 , \\ ( i = 2 ) ⇒ YP 1 = \frac{( 40 + 100 + 30 )}{( 80 + 200 + 60 )} \times 256 = 128$$

$$and$$

$$YP 2 = \frac{{\sum }_{n = i - 1}^{i + 1} DC\_An}{{\sum }_{n = i - 1}^{i + 1} TC\_Sn} \times 0 + \frac{{\sum }_{n = i - 1}^{i + 1} DC\_Bn}{{\sum }_{n = i - 1}^{i + 1} TC\_Sn} \times 256 , \\ ( i = 7 ) ⇒ YP 2 = \frac{( 30 + 150 + 80 )}{( 80 + 200 + 60 )} \times 256 = 208$$

Finally, the baselines BC_A3-BC_A6, BC_B3-BC_B6 of the sensing channels S3-S6 (i.e. the invalid sensing channels) are updated by the C_A3-C_A6, C_B3-C_B6, respectively.

Please note that, the main spirit of the present invention is calculating the coordinates of the touch points on the single layer capacitive touch device accurately according to the sensing capacitance of the single layer capacitive touch device. According to different applications, those skilled in the art may observe appropriate alternations and modifications. For example, the sensing capacitance C_A1-C_A8, C_B1-C_B8 may be affected by the environment noise. Thus, the sensing capacitance C_A1-C_A8, C_B1-C_B8 can be filtered via a low-pass filter while acquiring the sensing capacitance C_A1-C_A8, C_B1-C_B8. The low-pass filter can be realized in analog types or digital types. Besides, the low-pass filter may be an infinite impulse response (IIR) filter, a finite impulse response (FIR) filter or a median filter, and is not limited herein.

On the other hand, when multiple touch points locate on a same sensing channel, the capacitive touch module may midjudge the multiple touch points as one touch point. Thus, the coordinate calculating method of the above embodiment performs a virtual touch point algorithm when the number of the touch points currently outputted is smaller than that of the touch point previously outputted. The virtual touch point algorithm is utilized for determining whether the multiple touch points locate on a same sensing channel. When the multiple touch points locate on a same sensing channel, the virtual touch point algorithm further calculates the coordinates of the multiple touch points locating on a same sensing channel.

Noticeably, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits such as microcircuits, microchips, or silicon chips. Examples of the electronic system can include system on chip (SOC), system in package (Sip), computer on module (COM), and the capacitive touch module 40.

To sum up, the coordinate calculating method of the above embodiments can be utilized in the capacitive touch module with the single-layer capacitive device, for accurately calculating the coordinates of the touch points on the single-layer capacitive device. As a result, the designer can obtain precise touch resolution when implementing the thin low-cost single-layer capacitive device in the electronic product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coordinate calculating method for a single-layer capacitive touch device having a plurality of sensing channels, wherein each sensing channel corresponds to at least one sensing pad pair, a first end and a second end, the coordinate calculating method comprising:
acquiring a plurality of first end capacitances and a plurality of second end capacitances corresponding to the plurality of sensing channels;
calculating differences between the plurality of first end capacitances and a plurality of first baselines for acquiring a plurality of first differences and calculating differences between the plurality of second end capacitances and a plurality of second baselines for acquiring a plurality of second differences;
adding the first difference and the second difference corresponding to each sensing channel, for acquiring a plurality of total capacitances; and
determining whether the single-layer capacitive touch device is pressed according to the plurality of total capacitances and a threshold, and outputting coordinate of at least one touch point when the single-layer capacitive touch device is pressed.

2. The coordinate calculating method of claim 1, further comprising:
filtering the plurality of first differences and the plurality of second differences.

3. The coordinate calculating method of claim 1, wherein the step of determining whether the single-layer capacitive touch device is pressed according to the plurality of total capacitances and the threshold comprises:
utilizing the first end capacitance and the second end capacitance corresponding to a first sensing channel to update the first end baseline and the second end baseline corresponding to the first sensing channel when a first total capacitance corresponding to the first sensing channel is smaller than the threshold.

4. The coordinate calculating method of claim 1, wherein the step of determining whether the single-layer capacitive touch device is pressed according to the plurality of total capacitances and the threshold and outputting coordinate of at least one touch point when the single-layer capacitive touch device is pressed comprises:
determining whether a first total capacitance of a first sensing channel is greater than the total capacitance corresponding to at least one sensing channel adjacent to the first sensing channel when the first total capacitance is greater than the threshold.

5. The coordinate calculating method of claim 4, further comprising:
adjusting the differences and the total capacitances of the sensing channels located at edges of the single-layer touch device when the total capacitance of the first sensing channel is greater than the total capacitance corresponding to the at least one sensing channel adjacent to the first sensing channel;
outputting a first-axis coordinate of a touch point according to the total capacitances and first-axis coordinates of the first sensing channel and the at least one sensing channel adjacent to the first sensing channel; and
outputting a second-axis coordinate of the touch point according to the total capacitances, the first differences, the second differences and second-axis coordinates of the first sensing channel and the at least one sensing channel adjacent to the first sensing channel.

6. The coordinate calculating method of claim 5, wherein the step of outputting the first-axis coordinate of the touch point according to the total capacitances and the first-axis coordinates of the first sensing channel and the at least one sensing channel adjacent to the first sensing channel comprises:
outputting the first-axis coordinate of the touch point according to ratios between the total capacitances and the first-axis coordinates of the first sensing channel and the at least one sensing channel adjacent to the first sensing channel.

7. The coordinate calculating method of claim 5, wherein the step of outputting the second-axis coordinate of the touch point according to the total capacitances, the first differences, the second differences and the second-axis coordinates of the first sensing channel and the at least one sensing channel adjacent to the first sensing channel comprises:
outputting the second-axis coordinate of the touch point according to the ratios between the total capacitances, the first differences and the second differences and the second-axis coordinates of the first sensing channel and the at least one sensing channel adjacent to the first sensing channel.

8. The coordinate calculating method of claim 5, further comprising:
performing a virtual algorithm when the number of touch points currently outputted is smaller than the number of touch points previously outputted, for outputting a plurality of first-axis coordinates and a plurality of second-axis coordinates of a plurality of virtual touch points according to a plurality of first-axis coordinates and a plurality of second-axis coordinates of the previous touch points.

9. A touch module, comprising:
a single-layer capacitive touch device;
a processing unit; and
a storage unit for storing a program code, the program code instructs the processing unit to perform the following steps:
acquire a plurality of first end capacitances and a plurality of second end capacitances corresponding to the plurality of sensing channels;
calculate differences between the plurality of first end capacitances and a plurality of first baselines for acquiring a plurality of first differences and calculating differences between the plurality of second end capacitances and a plurality of second baselines for acquiring a plurality of second differences;
add the first difference and the second difference corresponding to each sensing channel, for acquiring a plurality of total capacitances; and
determine whether the single-layer capacitive touch device is pressed according to the plurality of total capacitances and a threshold, and outputting coordinate of at least one touch point when the single-layer capacitive touch device is pressed.

10. The touch module of claim 9, wherein the program code further instructs the processing unit to filter the plurality of first differences and the plurality of second differences.

11. The touch module of claim 9, wherein the processing unit utilizes the first end capacitance and the second end capacitance corresponding to a first sensing channel to update the first end baseline and the second end baseline corresponding to the first sensing channel when a first total capacitance corresponding to the first sensing channel is smaller than the threshold.

12. The touch module of claim 9, wherein the processing unit determines whether a first total capacitance of a first sensing channel is greater than the total capacitance corresponding to at least one sensing channel adjacent to the first sensing channel when the first total capacitance is greater than the threshold.

13. The touch module of claim 12, wherein when the first total capacitance is greater than the total capacitance corresponding to the at least one sensing channel adjacent to the first sensing channel, the program code further instructs the processing unit to perform the following steps:
adjust the differences and the total capacitances of the sensing channels located at edges of the single-layer touch device;
output a first-axis coordinate of a touch point according to the total capacitances and first-axis coordinates of the first sensing channel and the at least one sensing channel adjacent to the first sensing channel; and
output a second-axis coordinate of the touch point according to the total capacitances, the first differences, the second differences and second-axis coordinates of the first sensing channel and the at least one sensing channel adjacent to the first sensing channel.

14. The touch module of claim 13, wherein the processing unit outputs the first-axis coordinate of the touch point according to ratios between the total capacitances and the first-axis coordinates of the first sensing channel and the at least one sensing channel adjacent to the first sensing channel.

15. The touch module of claim 13, wherein the processing unit outputs the second-axis coordinate of the touch point according to the ratios between the total capacitances, the first differences and the second differences and the second-axis coordinates of the first sensing channel and the at least one sensing channel adjacent to the first sensing channel.

16. The touch module of claim 13, the program code further instructs the processing unit to perform a virtual algorithm when the number of touch points currently outputted is smaller than the number of touch points previously outputted, for outputting a plurality of first-axis coordinates and a plurality of second-axis coordinates of a plurality of virtual touch points according to a plurality of first-axis coordinates and a plurality of second-axis coordinates of the previous touch points.
